(19) United States
(12) Patent Application Publication
(10) Pub. No.: US 2005/0086356 A1
(43) Pub. Date: Apr. 21, 2005

(54) Systems and methods for scheduled recording of multimedia content streams

(76) Inventors: Mehul Y. Shah, Bellevue, WA (US); Vladimir Rovinksy, Redmond, WA (US)

Correspondence Address: LEE & HAYES PLLC, 421 W RIVERSIDE AVENUE SUITE 500, SPOKANE, WA, 99201, US

(21) Appl. No.: 10/686,361

(22) Filed: Oct. 15, 2003

(51) Int. Cl. G06F 15/16

(52) U.S. Cl. 709/231

(57) ABSTRACT

Systems and methods for scheduled recording of multimedia content streams are described herein. A scheduled recording service (SRS) is configured to receive information about a multimedia content stream provided by a device in a computer network and schedule a recording of the multimedia content stream at a specified time. At the specified time, the scheduled recording service receives the multimedia content stream from the device and saves the multimedia content stream in local system storage. A scheduling application (SA) is configured to provide a user interface for interacting with the scheduled recording service.

### TECHNICAL FIELD

The systems and methods described herein relate to multimedia content and, more particularly, to recording of streaming multimedia content.

### BACKGROUND

Presentations such as movies, commercials, song albums, music concerts, and news broadcast may be represented by multimedia content. It is becoming more commonplace for computers to render (i.e., play) multimedia content. Multimedia content may be stored in a local source such as a hard disk, DVD drives, CD drives, and the like. Increasingly, multimedia content is stored on content servers and is streamed to other computers through a computer network.

Streaming multimedia content typically involves transmitting multimedia content from a content server (i.e., a web server) across a network in a continuous flow. A computer, and in particular a media player application executed by the computer, may begin rendering the multimedia content immediately instead of waiting for an entire file of the multimedia content to be downloaded from the source.

Multimedia content streams may include audio/video programs such as music concerts, promotional content such as commercials and movie trailers, and live broadcasts of news events. Multimedia content streams may be made available to other computers in many forms, such as “on-demand” streams and “broadcast” streams. For an “on-demand” stream, a computer uses a media player to control the playback experience such as when to start playback, when to pause playback, when to stop playback, and when to seek to a specific position in the stream. For a “broadcast” stream, a server from which the multimedia content stream originates controls the playback experience, such as when streaming starts and when streaming ends.

Streaming enables computer users to conveniently and economically access a variety of multimedia content. However, streaming is not a very reliable and consistent means of accessing multimedia content. For example, users may only have a limited amount of time to access multimedia content streams from a content server. Thus, the users would have to be available for downloading the multimedia content streams at the same time that the streams are available. Also, the playback experience of multimedia content streams largely depends on the available bandwidth of the network connection. A slow network connection can significantly degrade the playback quality of the multimedia content streams.

Thus, there is a need for a system that enables users to access multimedia content streams reliably and consistently.

### SUMMARY

The systems and methods described herein are directed at scheduled recording of multimedia content streams. In one aspect, the systems and methods receive information about a multimedia content stream provided at a location in a computer network and schedule a recording of the multimedia content stream at a specified time. Upon determining the specified time, the systems and methods receive the multimedia content stream from the location and save the multimedia content stream in local storage such as system memory, hard disk, and other computer-readable media.

In another aspect, the systems and methods enable a user to schedule a recording of a multimedia content stream at a specified time and create a scheduled recording task that includes information about the recording. The systems and methods send the scheduled recording task to a service configured to perform the scheduled recording task and track the scheduled recording task.

### BRIEF DESCRIPTION OF THE DRAWINGS

FIG. 1 is a graphical representation of a networking environment within which the systems and methods for scheduled recording of multimedia content streams can be either fully or partially implemented.

FIG. 2 is a graphical representation of example logical components associated with a scheduling application and a scheduled recording service.

FIG. 3 is a screenshot of an example user interface that may be implemented by a scheduling application.

FIG. 4 is a screenshot of another example user interface that may be implemented by a scheduling application.

FIG. 5 is an operational flow diagram of an example process that may be implemented by a scheduled recording service to handle a scheduled recording task.

FIG. 6 is an operational flow diagram of an example process that may be implemented by a scheduling application to enable a user to schedule a recording of a multimedia content stream.

FIG. 7 illustrates an example computer within which the systems and methods for scheduled recording of multimedia content streams can be either fully or partially implemented.

### DETAILED DESCRIPTION

Streaming is a convenient and economical mechanism for a user to access multimedia content through a computer network. However, there are circumstances in which the user may not be able to obtain the multimedia content streams when they are available or may not be able to obtain the multimedia content streams having the desired quality. For example, the user may not be available to obtain the multimedia content streams during the window of time when the streams are provided. Also, the user's network connection may not allow the user to consistently download and playback the multimedia content streams due to bandwidth limitations.

Thus, the systems and methods discussed herein provide for scheduled recording of multimedia content streams. These systems and methods enable a user to schedule an automatic recording of a multimedia content stream at a specified time. The user may control the various ways in which the multimedia content stream may be obtained and recorded. The systems and methods allow the user to enjoy the multimedia content stream even if the user was unavailable to access the stream when it was provided. The systems and methods also enable the user to defer downloading the multimedia content stream until a time when the necessary network communication bandwidth is available.

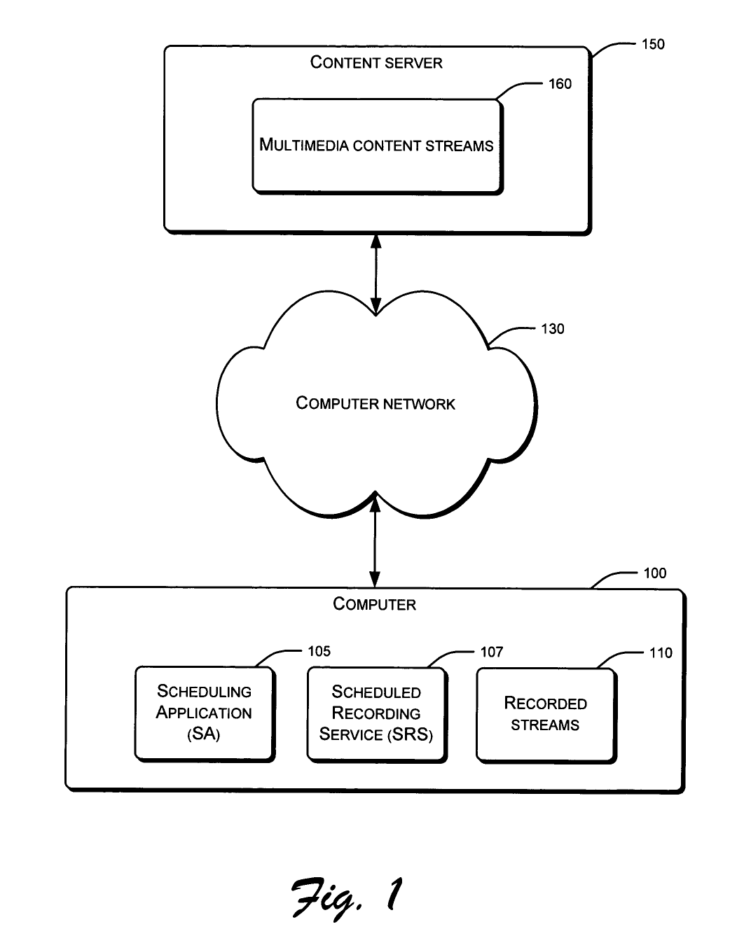

FIG. 1 is a graphical representation of a networking environment within which the systems and methods for scheduled recording of multimedia content streams can be either fully or partially implemented. As shown in FIG. 1, computer 100 and content server 150 are connected through computer network 130.

Content server 150 is a computer that is configured to make multimedia content streams 160 available for downloading by other computers. Multimedia content streams 160 may include many forms of content, such as audio content, video content, graphics, and the like. The content in multimedia content streams 160 may be encoded in any type of media file formats suitable for streaming, such as Moving Picture Experts Group (MPEG) files, Windows Media files, Advanced Streaming Format (ASF) files, ASF Stream Redirector (ASX) files and the like. Multimedia content streams 160 may be any types of streams, such as on-demand streams and broadcast streams. Content server 150 may be configured to make multimedia content streams 160 available for only a limited amount of time. Computer network 130 may include any type of computer network such as a local area network (LAN), wide area network (WAN) (e.g. the Internet), and the like. Further, computer network 130 may be a combination of two or more different networks, such as a LAN coupled to the Internet.

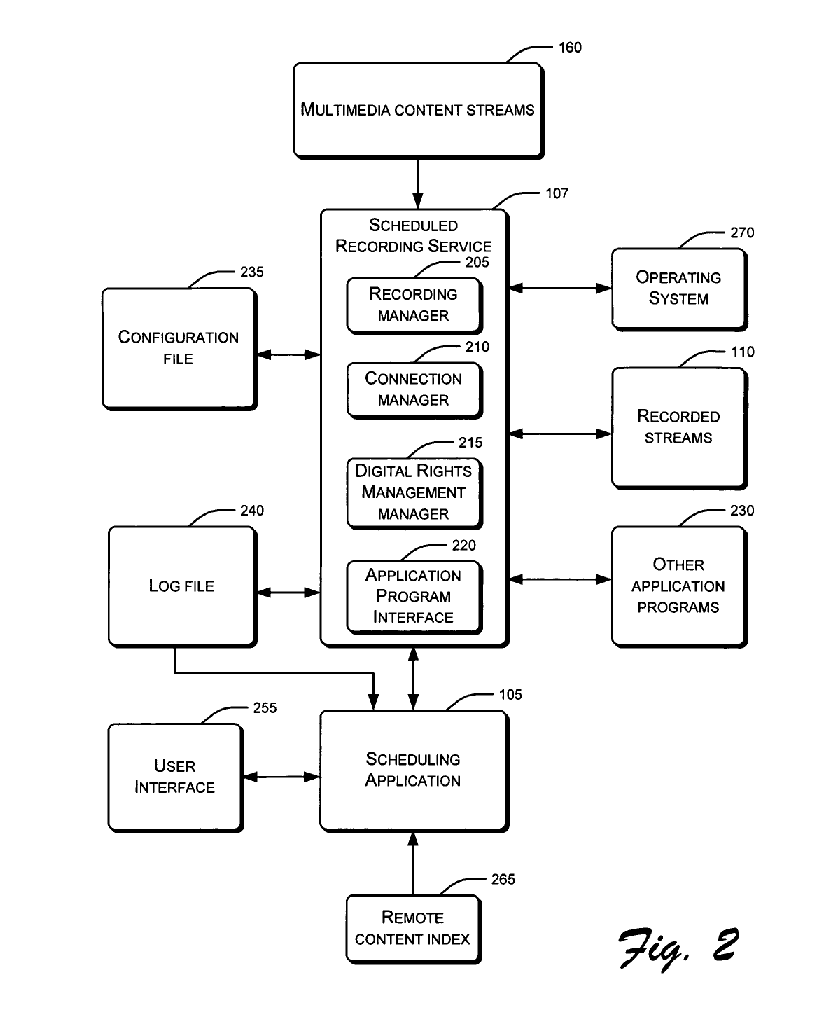

Computer 100 is configured to communicate with content server 150 through computer network 130 for accessing and recording multimedia content streams 160. For this purpose, computer 100 may be configured with scheduling application 105 and scheduled recording service 107. Scheduling application 105 and scheduled recording service 107 will be discussed in more detail in conjunction with FIG. 2. Briefly stated, scheduled recording service 107 is a computer-executable component configured to download multimedia content streams 160 from content server 150 at a specified time and to save the streams as recorded streams 110 in the local storage of computer 100. Scheduling application 105 is a computer-executable component configured to enable a user to schedule the recording of multimedia content stream 160 and to interact with scheduled recording service 107 to implement the scheduled recording.

FIG. 2 is a graphical representation of example logical components associated with scheduling application 105 and scheduled recording service 107. These example logical components are shown for the ease of discussion. In practice, scheduling application 105 and scheduled recording service 107 may include more or less logical components than those shown in FIG. 2.

Scheduled recording service 107 is configured to provide multimedia stream recording services to computer 100. In one embodiment, scheduled recording service 107 is configured to directly interact with operation system (OS) 270 of computer 100 to provide such services. In such a configuration, Scheduled recording service 107 may operate independent of a particular user's account, which enables scheduled recording service 107 to execute even when no user is logged on and to perform recording for multiple users.

As shown in FIG. 2, scheduled recording service 107 may include recording manager 205, connection manager 210, digital rights management (DRM) manager 215 and application program interface (API) 220. Connection manager 210 is a logical component configured to establish a network connection with a content server. Connection manager 210 may interact with other software and hardware components in computer 100 to establish the connection. To preserve communication resources and to enhance security, connection manager 210 may be configured to establish a network connection only for a limited time that is sufficient for receiving a multimedia content stream scheduled to be recorded. Connection manager 210 may also be configured to establish network connections to multiple content servers for concurrently receiving multiple multimedia content streams.

Digital rights management manager 215 is a logical component that is configured to implement a digital rights management system on scheduled recording service 107 and to enable to interact with other digital rights management systems. A digital rights management system protects the copyrights of data circulated via the Internet by enabling secure distribution and/or disabling illegal distribution of the data. Typically, a digital rights management system protects intellectual property by encrypting the data so that the data can only be accessed by authorized users, marking the content with a digital watermark, or similar method so that the content can not be freely distributed. In one embodiment, the digital rights management manager 215 may encrypt multimedia content that is recorded and saved in local storage by scheduled recording service 107 such that the multimedia content can only be played back on the same computer and cannot be shared to other users for playback on other computers.

Recording manager 205 is a logical component configured to handle the tasks associated with the receiving and recording of multimedia content streams 160. Recording manager 205 is configured to receive a scheduled recording task associated with a multimedia content stream from scheduling application 105 and other application programs 230 through application program interface 220 and to perform the scheduled recording at the specified time in accordance with the scheduled recording tasks. The scheduled recording tasks may include a start time and an end time, the location of the multimedia content stream such as a Uniform Resource Locator (URL), and other relevant information. Scheduled recording service 107 may be configured to maintain configuration file 235 for storing information associated with scheduled recording tasks. Many different kinds of information associated with a scheduled recording task may be stored in configuration file 235. Below are some examples of information associated with a scheduled recording task that may be stored in configuration file 235:
(a) A unique identifier associated with the scheduled recording task. The identifier may be globally unique identifier (GUID), a unique integer value, and the like.
(b) The user account name of the user who created the scheduled recording task. Multiple users can log on to a computer. Each user has a user account and is authenticated when the user logs on. When the user creates a new scheduled recording task, the log on account name of the user may be maintained for security reasons. For example, scheduled recording service 107 may be configured such that information about a scheduled recording task can be modified only by the user who created the scheduled recording task and by administrators of the computer. Users may be prevented from editing or deleting the scheduled recording task initiated by other users. Additional options may be configured to provide privacy where a user can only view those scheduled recording tasks which were created by that user.
(c) The date and time when the scheduled recording should start and the duration of the recording. Scheduled recording service 107 may be configured such that if the actual duration of the multimedia content stream is longer than the duration specified in the configuration file, the scheduled recording task is stopped after recording for the duration specified in the configuration file. scheduled recording service 107 may also be configured such that if the actual duration of the multimedia content stream is less than the duration specified in the configuration file, the schedule recording task stops when the stream has been recorded.
(d) The title for the scheduled recording task. When a user schedules a recording, the user can specify a title for the scheduled recording task for reference. The user may use descriptive names to enhance organization and identification of recordings.
(e) The URL from which the content will be streamed at the scheduled time. This is typically a URL of a server or other device accessible via the Internet.
(f) The path of the local folder in which the recorded stream should be saved.

Configuration file 235 may be implemented in any file format. In one embodiment, configuration file 235 is implemented as an extensible markup language (XML) file. To enhance security, configuration file 235 may be saved at a secure location in the system memory such that the file is accessible only to administrators and to scheduled recording service 107. Configuration file 235 may also be configured so that only scheduled recording service 107 may read from and write to it.

At the start time specified in a scheduled recording task, recording manager 205 is configured to interact with connection manager 210 to establish a connection with the specified location. When a connection with the specified location is established, one or more multimedia content streams are received in accordance with the scheduled recording task. In one embodiment, the recording manager 205 is required to perform operations to download the multimedia content streams. For example, recording manager 205 may have to interact with a device at the specified location to configure various parameters associated with the downloading such as using a modem to dial up a connection to the internet. The multimedia content streams are saved in the system as recorded streams 110. Digital rights management manager 215 may be configured to control the digital rights management aspects of the downloading and saving operations.

Recording manager 205 may be configured to maintain a log file 240 that contains information about scheduled recording tasks that have been completed or have failed. Log file 240 may be read by scheduling application 105 to present the status of completed or failed scheduled recording tasks to the user. Many different kinds of information associated with a scheduled recording task may be stored in log file 240. Below are some examples of information associated with a scheduled recording task that may be stored in log file 240:
(a) A unique identifier associated with the scheduled recording task.
(b) The user account name of the user who scheduled the recording task.
(c) The title for the scheduled recording task.
(d) The URL associated with the scheduled recording task.
(e) An indication of whether the recording task was completed or failed.
(f) If the recording was successful, the path of the file in which the recorded multimedia content stream was saved. If the recorded multimedia content stream was in the form of an ASX file with links to other audio/video files, the ASX file is updated to point to locally saved audio/video files and is saved.
(g) If the recording failed, a failure error code and brief description of the reason for failure.
(h) The date and time when the schedule recording task was performed.

Log file 240 may be implemented in any file format. In one embodiment, log file 240 is implemented as an XML file. Log file 240 may be saved in a location where it can be accessible for read access by all users, but for write access only by administrators and by scheduled recording service 107. If scheduled recording service 107 is used over a period of time, log files 240 may contain entries associated with numerous scheduled recording tasks. Log files 240 may be trimmed at regular intervals by removing older entries. This could either be done manually by administrators or automatically by scheduled recording service 107 where the entries are removed after a specified period.

To enhance privacy, scheduled recording service 107 may be configured to create one log file per user, which can result in multiple log files. Information about scheduled recording tasks for each user is saved in a log file for that user, which is only accessible for read and write access by that user, by administrators of the computer, and by scheduled recording service 107. In this configuration, the log file for the user could be trimmed at regular intervals manually by that user, system administrators, or scheduled recording service 107. An interface for trimming the log file and for removing specific entries from the log file may be provided by scheduling application 105.

Application program interface 220 is logical interface that enables scheduled recording service 107 to interact with scheduling application 105 and other application programs 230. In particular, application program interface 220 allows scheduled recording service 107 to expose its functionalities to other application programs. Application program interface 220 may be implemented in many different interface configurations. In one embodiment, application program interface 220 is configured as a distributed component object model (DCOM) interface. Application program interface 220 may expose methods to perform many different operations. Below are examples of these operations:
(a) Create a scheduled recording task by providing information such as the URL, recording location, date and time of recording, recording duration, title for the recording task, and the like.
(b) Query the list of scheduled recording tasks and information about these scheduled recording tasks.
(c) Update information for any scheduled recording task such as the duration, title, date and time to start recording, URL to record from, and the like. Only administrators or the user who first created the scheduled recording task can update this information.
(d) Delete a scheduled recording task. Only administrators or users who first created scheduled recording task can delete it.
(e) Query to obtain a list of all scheduled recording tasks currently in progress.
(f) Clear the log file of entries of previous scheduled recording tasks. Only administrators or users who created the corresponding scheduled recording task for a log file entry can clear information about that log file entry from the log file.

Scheduled recording service 107 may be configured to have a workflow that is compatible with operating system 270. For example, when scheduled recording service 107 starts up, it may be configured to read configuration file 235 and store in system memory information about scheduled recording tasks made by all users of the computer. The main application thread of scheduled recording service 107 then goes into a wait (i.e., idle) state. The main application thread may wake up from idle state in any of the following cases:
(a) When it is time for the first scheduled recording task to be started;
(b) When a user makes a request to add, modify or delete a scheduled recording task using application program interface 220;
(c) When a previously started scheduled recording task ends; or
(d) When scheduled recording service 107 needs to be shut down because an administrator of the system wants the service to be shut down or because operating system 270 is shutting down.

In the case that the main application thread wakes up due to case (a), scheduled recording service 107 reads information about the scheduled recording task which needs to be started and generates a worker thread to perform the scheduled recording task. Scheduled recording service 107 creates a recording context to maintain information about the scheduled recording task in progress and the thread ID of the thread that performs the scheduled recording task. Scheduled recording service 107 contains a list of such recording contexts where each item represents a scheduled recording task that is currently in progress. Once the worker thread is generated to perform the recording task, the main application thread of scheduled recording service 107 goes back into the idle state.

In the case that the main application thread wakes up due to case (b), scheduled recording service 107 performs the requested change to add, modify or delete a scheduled recording task in configuration file 235 and correspondingly updates the data in system memory about all scheduled recording tasks. Scheduled recording service 107 also re-computes the time duration left before the first scheduled recording task needs to be started. Once that is done, the main application thread of scheduled recording service goes back into the idle state.

In the case that the main application thread wakes up due to case (c), scheduled recording service 107 determines the recording context of the scheduled recording task which has just completed and removes the recording context from the list of all recording contexts that represent scheduled recording tasks currently in progress. Scheduled recording service 107 also adds information in log file 240 about the completion state (success/failure) of the scheduled recording task. If the recording that was completed is not a recurring event, scheduled recording service 107 removes the entry about this scheduled recording task from configuration file 235. If the recording which was completed is a recurring scheduled event and the stream needs to be recorded again after some interval, the entry for this scheduled recording task is not removed from configuration file 235. The main application thread then again goes back into the idle state.

In the case that the main application thread wakes up due to case (d), scheduled recording service 107 first triggers all currently recording worker threads to be shut down irrespective of partial completion and empties the list of recording contexts that contain information about currently recording tasks. When the worker threads that perform the actual recordings are interrupted this way, suitable entries are added to log file 240 to indicate partial completion. Once all worker threads exit, the main application thread exits and scheduled recording service 107 shuts down.

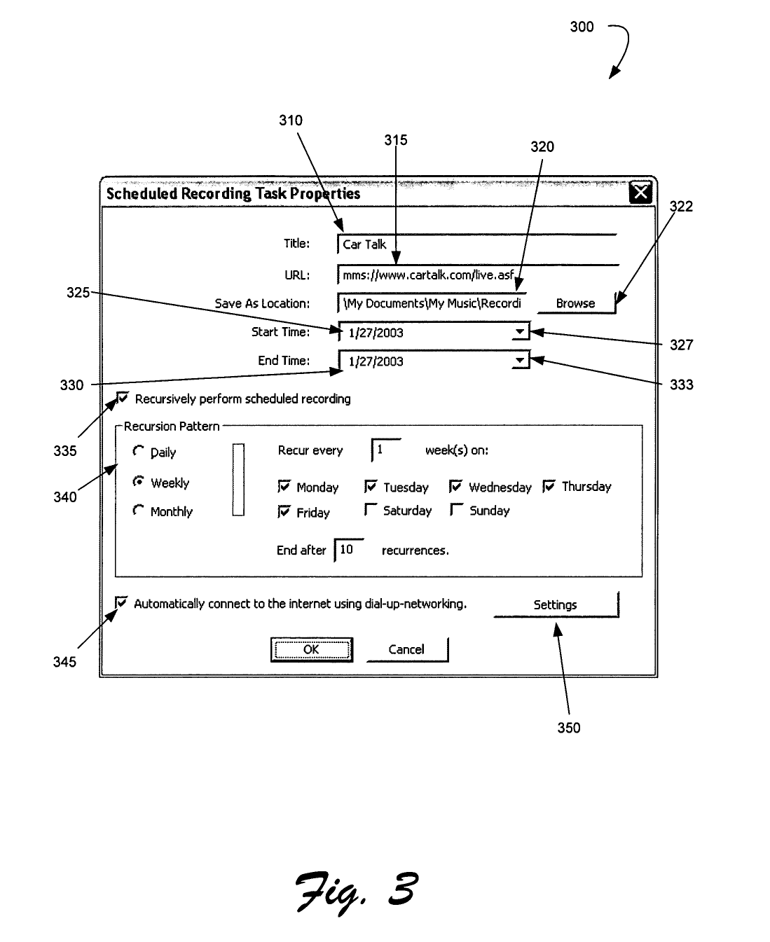

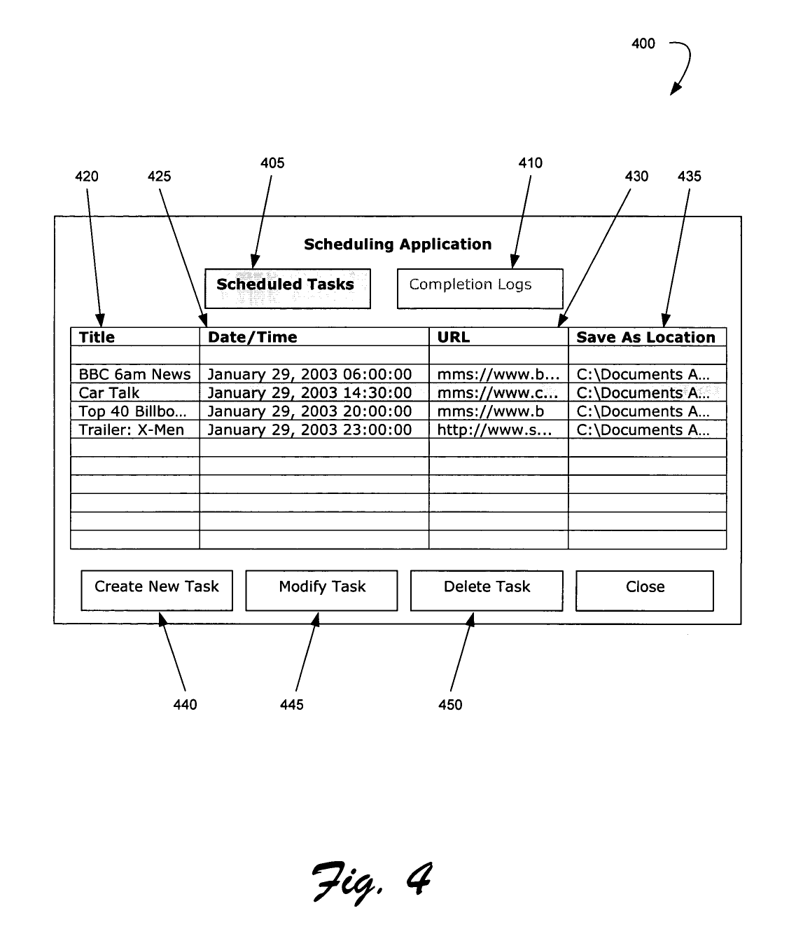

Scheduling application 105 is configured to enable a user to interact with scheduled recording service 107. As shown in the FIG. 2, scheduling application 105 may provide a user interface (UI) 255 for this purpose. Two examples of user interface 255 will be discussed in more detail in conjunction with FIG. 3 and FIG. 4. Briefly stated, user interface 255 enables a user to assign scheduled recording tasks and obtain information related to the schedule recording tasks. Below are examples of operations that a user may perform using user interface 255:
(a) View a list of all scheduled recording tasks to be performed.
(b) Create a new scheduled recording task.
(c) Update a scheduled recording task.
(d) Delete a scheduled recording task.
(e) View log files to check whether a previously scheduled recording task was completed successfully.
(f) View a list of all scheduled recording tasks that are currently in progress.
(g) Clear the log file of entries of previously scheduled recording tasks. Only administrators or users who created the corresponding scheduled recording task for a log file entry can clear information about that log file entry from the log file.
   Scheduling application 105 may perform these operations through application program interface 220.

Scheduling application 105 may also interact with remote content index 265 to obtain information about multimedia content streams that are available. Remote content index 265 may be stored in a remote server accessible by scheduling application 105 through a computer network. Remote content index 265 may include information about a multimedia content stream, such as a title and a description of content, the type of the stream, the URL of the stream, when the stream will be available, and the like. Scheduling application 105 may present the title and the description about the stream to the user and, if the user selects to record the stream, may automatically send a request to scheduled recording service 107 to record the stream.

FIG. 3 is a screenshot of an example user interface 300 that may be implemented by scheduling application 105. User interface 300 may include many data fields for a user to enter information about a scheduled recording task. Scheduling application 105 uses this information to create a schedule recording task for sending to scheduled recording service 107. As shown in FIG. 3, user interface 300 includes title data field 310, remote location data field 315, local storage location field 320, start time data field 325, and end time data field 330.

Title data field 310 enables the user to associate a title with the scheduled recording task. The title may be descriptive of the content in the multimedia content stream to be recorded so that the user may easily track the scheduled recording task by its title. In this example, the title of the scheduled recording task is “Car Talk”.

Remote location data field 315 allows the user to associate the location of the multimedia content stream to be recorded with the scheduled recording task. The location is typically a URL. In this example, the location is “mms://www.cartalk.com/live.asf”.

Local storage location field 320 enables the user to specify a location where the multimedia content stream should be stored in the system memory. The specified location is typically a file directory. The user may enter the directory or may browse through available directories by activating the directory browse trigger 322. The directory chosen in this example is “\My Documents\My Music\Recording”.

Start time data field 325 allows the user to specify the date and time when the scheduled recording task should begin. End time data field 330 allows the user to specify the date and time when the scheduled recording task should end. The user may enter or select the start time and end time by activating the start time selector trigger 327 and the end time selector trigger 333, respectively.

User interface 300 may enable the user to configure scheduling application 105 to recursively perform a scheduled recording task. The user may access recursion pattern selection fields 340 by activating recursive recording selector 335. As shown in FIG. 3, the selections in recursion pattern selection fields 340 set the scheduled recording task to be performed once every week on Monday, Tuesday, Wednesday, Thursday and Friday, and will end after 10 recurrences.

User interface 300 may also enable the user to configure scheduling application 105 to automatically connect to the Internet for the scheduled recording task. The user may select this feature by selecting automatic connection selector 345. The user may also select the connection settings by selecting settings selection trigger 350 and making the connection settings selections using a menu that is displayed in response to the activation of the trigger.

FIG. 4 is a screenshot of another example user interface 400 that may be implemented by scheduling application 105. A user may use user interface 400 to manage scheduled recording tasks. Page indicator 405 is highlighted, which indicates that user interface 400 is currently displaying scheduled recording tasks that are active. If page indicator 410 is highlighted, that would indicate that task completion logs are displayed (not shown).

As shown in FIG. 4, user interface 400 includes four columns of information about active scheduled recording tasks. Column 420 shows the titles associated with scheduled recording tasks. Column 425 shows the date and start time of the tasks. Column 430 shows the URL associated with the tasks. Column 435 shows the locations in system memory where the downloaded multimedia content streams associated with the tasks are to be saved. A user may also add, modify and delete a task by activating create new task trigger 440, modify task trigger 445 and delete task trigger, respectively.

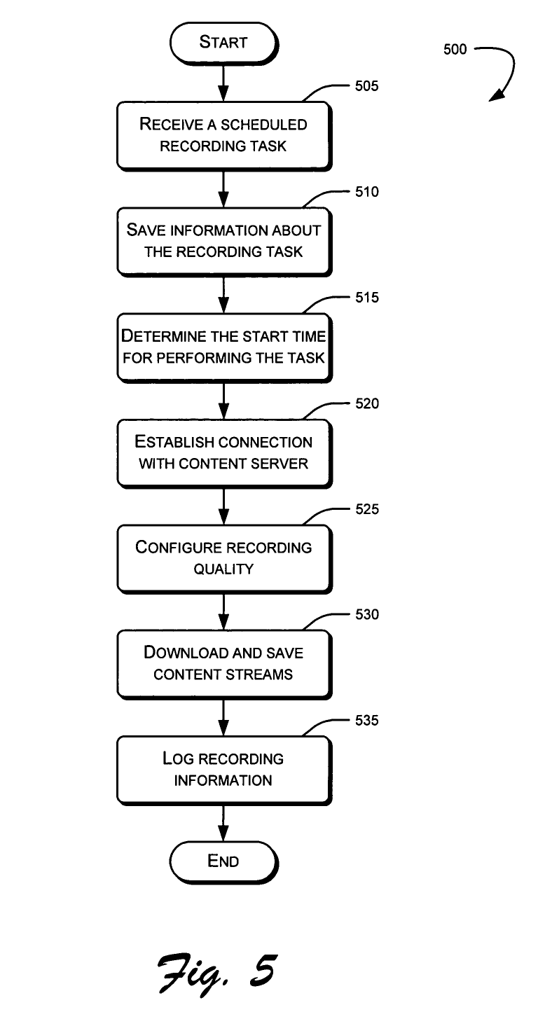

FIG. 5 is an operational flow diagram of an example process 500 that may be implemented by a scheduled recording service to handle a scheduled recording task. Moving from a start block, process 500 goes to block 505 where a scheduled recording task is received. The scheduled recording service may receive a scheduled recording task by interacting with an application program through an application program interface. The scheduled recording task includes information for recording a multimedia content stream.

At block 510, information about the scheduled recording task is saved. The scheduled recording service may save the information in a configuration file. At block 515, the start time for the scheduled recording task is determined. The scheduled recording service may make this determination by monitoring a system timer. At block 520, a connection with a content server is established. The scheduled recording task may include information about the location of the content server, which is typically a URL. The scheduled recording task may also specify the settings associated with the connection.

At block 525, the quality of the multimedia content stream associated with the scheduled recording task is configured. The scheduled recording service may interact with the content server to make this configuration. In one embodiment, the scheduled recording service may be configured to obtain the best quality available given the bandwidth of the connection. In another embodiment, the quality may be specified by the scheduled recording task and the scheduled recording service may be configured to obtain the streams with the specified quality if that quality is available.

At block 530, the multimedia content stream is downloaded from the content server and saved in the system memory. The scheduled recording task may include the location where the multimedia content stream is to be saved in the system memory.

At block 535, the information about the recording of the multimedia content stream associated with the scheduled recording task is logged. The scheduled recording service may save the information in a log file, which may be accessed by the application program that sent the scheduled recording task. Process 500 then ends.

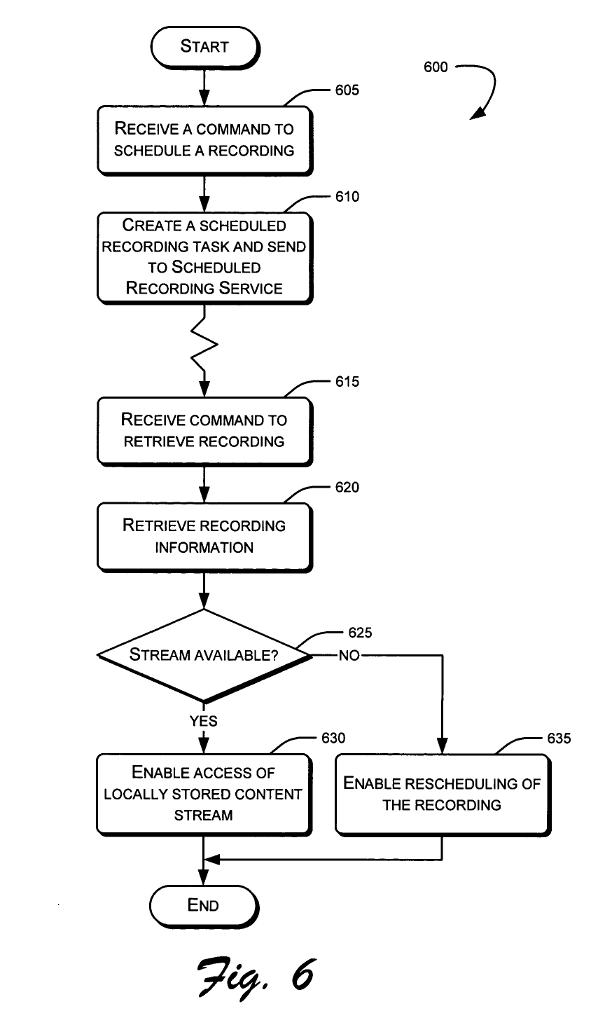

FIG. 6 is an operational flow diagram of an example process 600 that may be implemented by a scheduling application to enable a user to schedule a recording of a multimedia content stream. Moving from a start block, process 600 goes to block 605 where a command to schedule a recording of a multimedia content stream is received from a user. The user may issue the command through a UI associated with the scheduling application.

At block 610, a scheduled recording task is created in response to the command by the user. The scheduled recording task may include information about the multimedia content stream and the various aspects of the recording. The information may be supplied by the user, a remote content index, or some other sources. The scheduled recording task is then sent to the scheduled recording service.

Some time later (as indicated by the irregular line), process 600 moves to block 615 where a command to retrieve the multimedia content stream associated with the scheduled recording task is received from a user. At block 620, the information about the recording is retrieved. The scheduling application may retrieve the information by accessing a log file maintained by the scheduled recording service.

At decision block 625, a determination is made whether the multimedia content stream is available for accessing by the user. If so, the scheduled recording task associated with the multimedia content stream was performed successfully. Process 600 moves to block 630 where the multimedia content stream stored in the system memory is made available to the user and the process ends.

Returning to decision block 625, if the multimedia content stream is not available, then the scheduled recording task associated with the multimedia content stream failed. Process 600 moves to block 635 where the scheduled recording task may be rescheduled. The rescheduling of the scheduled recording task may be specified by the user or may be automatically done if the task failed.

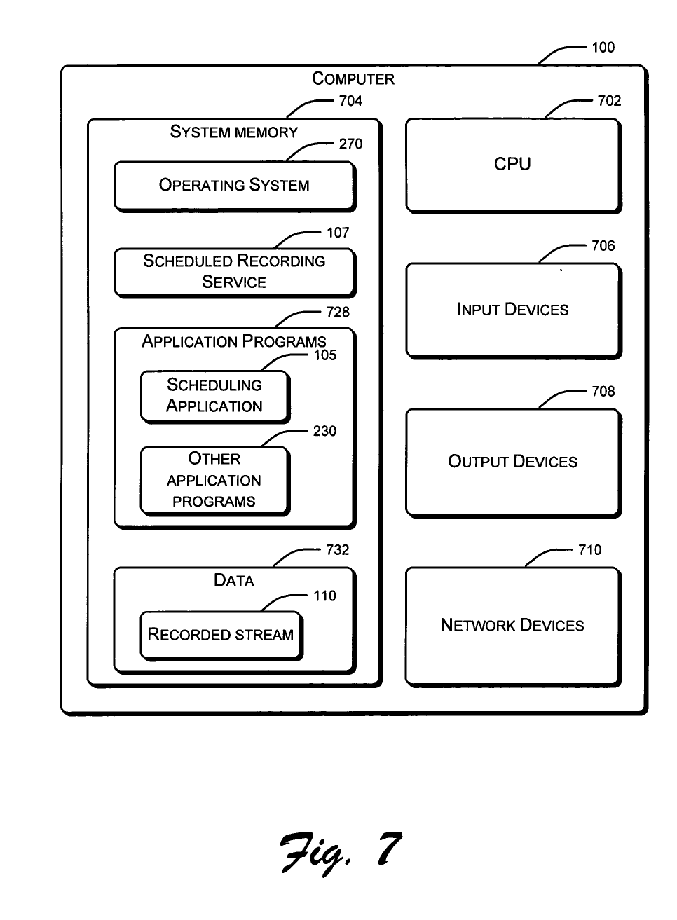

FIG. 7 illustrates an example computer 100 within which the systems and methods for scheduled recording of multimedia content streams can be either fully or partially implemented. Computer 100 is only one example of a computing system and is not intended to suggest any limitation as to the scope of the use or functionality of the invention.

Computer 100 can be implemented with numerous other general purpose or special purpose computing system environments or configurations. Examples of well known computing systems, environments, and/or configurations that may be suitable for use include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, gaming consoles, distributed computing environments that include any of the above systems or devices, and the like.

The components of computer 100 can include, but are not limited to, processor 702 (e.g., any of microprocessors, controllers, and the like), system memory 704, input devices 706, output devices 708, and network devices 710.

Computer 100 typically includes a variety of computer-readable media. Such media can be any available media that is accessible by computer 100 and includes both volatile and non-volatile media, removable and non-removable media. System memory 704 includes computer-readable media in the form of volatile memory, such as random access memory (RAM), and/or non-volatile memory, such as read only memory (ROM). A basic input/output system (BIOS), containing the basic routines that help to transfer information between elements within computer 100, such as during start-up, is stored in system memory 704. System memory 704 typically contains data and/or program modules that are immediately accessible to and/or presently operated on by processor 702.

System memory 704 can also include other removable/non-removable, volatile/non-volatile computer storage media. For system memory 704, a hard disk drive may be included for reading from and writing to a non-removable, non-volatile magnetic media; a magnetic disk drive may be included for reading from and writing to a removable, non-volatile magnetic disk (e.g., a “floppy disk”); and an optical disk drive may be included for reading from and/or writing to a removable, non-volatile optical disk such as a CD-ROM, DVD, or any other type of optical media.

The disk drives and their associated computer-readable media provide non-volatile storage of computer-readable instructions, data structures, program modules, and other data for computer 100. It is to be appreciated that other types of computer-readable media which can store data that is accessible by computer 100, such as magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like, can also be utilized to implement exemplary computer 100.

Any number of program modules can be stored in system memory 704, including by way of example, an operating system 270, application programs 728, data 732, and scheduled recording service 107. As shown in the figure, application programs 728 include scheduling application 105 and other application programs 230.

Computer 100 can include a variety of computer-readable media identified as communication media. Communication media typically embodies computer-readable instructions, data structures, program modules, or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer-readable media.

A user can enter commands and information into computer 100 via input devices 706 such as a keyboard and a pointing device 736 (e.g., a “mouse”). Other input devices 706 may include a microphone, joystick, game pad, controller, satellite dish, serial port, scanner, touch screen, touch pads, key pads, and/or the like. Output devices 708 may include a CRT monitor, LCD screen, speakers, printers, and the like.

Computer 100 may include network devices 710 for connecting to computer networks, such as local area network (LAN), wide area network (WAN), and the like.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

In conclusion, the systems and methods described above enable a user to record multimedia content streams at a scheduled time. These systems and methods have many advantages. For example, in case of broadcast content streams, if the user is unable to view a stream at the time of broadcast, the systems and methods would allow the user to schedule a recording of the broadcast stream ahead of time by specifying the start and end time of the broadcast. The stream would then be recorded at the broadcast time and saved locally on the user's computer. The user could watch the saved stream at a later time.

In case of on-demand content streams, if the bandwidth requirement of a stream is higher than the bandwidth available using the user's internet connection, the user may not be able to watch the stream smoothly if the stream is downloaded and viewed in real-time. There would be interruptions due to the low bandwidth. In this case, the systems and methods would allow the user to schedule a recording of the stream at a later time. Then, at the specified time, the streams could be downloaded at the available bandwidth and saved locally. The user could watch the saved content at a later time without any interruptions. The systems and methods also enable the user to select a higher quality streams, resulting in more enjoyable viewing experience than the bandwidth would allow if downloaded and viewed in real-time.

Also, watching the streaming content in real time may use up a large portion of the internet connection bandwidth available to the user in order to download the stream. The user may want to utilize the internet connection bandwidth for other purposes and be able to download the stream at a later time when no other application needs the internet connection bandwidth. The systems and methods would allow the user to schedule a recording of the stream at a later time when the internet connection is unused.

1. A computer-implemented method comprising:
receiving information about a multimedia content stream generated by a device in a computer network, wherein the received information includes a specified time associated with the multimedia content stream;
scheduling a recording of the multimedia content stream at the specified time; and
at the specified time,
receiving the multimedia content stream from the device; and
saving the multimedia content stream in a system memory.

2. The computer-implemented method as recited in claim 1, wherein the device is a content server connected to the computer network.

3. The computer-implemented method as recited in claim 1, wherein the information about the multimedia content stream includes a network address associated with the location.

4. The computer-implemented method as recited in claim 3, wherein the network address is a uniform resource locator (URL).

5. The computer-implemented method as recited in claim 1, wherein the information about the multimedia content stream is received through an application program interface.

6. The computer-implemented method as recited in claim 5, wherein the application program interface includes a distributed component object model (DCOM) interface.

7. The computer-implemented method as recited in claim 1, wherein receiving information about the multimedia content stream includes receiving a scheduled recording task.

8. The computer-implemented method as recited in claim 7, wherein the scheduled recording task includes at least one of a unique task identifier, a user account identifier, a title, a start time, a start date, an end time, an end date, a recording duration, a URL, a local storage location, a recording quality identifier, and connection settings.

9. The computer-implemented method as recited in claim 1, further comprising at the specified time, automatically connecting to the device.

10. The computer-implemented method as recited in claim 9, wherein automatically connecting to the device is performed in accordance with connection settings included in the information about the multimedia content stream.

11. The computer-implemented method as recited in claim 1, wherein receiving the multimedia content stream includes specifying a quality of the stream.

12. The computer-implemented method as recited in claim 1, wherein receiving the multimedia content stream includes specifying a quality of the stream in relation to a bandwidth associated with a network connection.

13. The computer-implemented method as recited in claim 1, wherein the multimedia content stream includes at least one of an on-demand content stream and a broadcast content stream.

14. The computer-implemented method as recited in claim 1, wherein the computer network includes at least one of a local area network (LAN), a wide area network (WAN), and the Internet.

15. One or more computer-readable memories containing a computer program that is executable by a processor to perform the computer-implemented method recited in claim 1.

16. A computer-implemented method comprising:
enabling a user to schedule a recording of a multimedia content stream at a specified time;
creating a scheduled recording task that includes information about the recording of the multimedia content stream;
sending the scheduled recording task to a recording service configured to perform the scheduled recording task; and
tracking the scheduled recording task.

17. The computer-implemented method as recited in claim 16, wherein enabling the user to schedule the recording includes providing a user interface that enables the user to input the information about the recording.

18. The computer-implemented method as recited in claim 16, wherein the information about the recording includes at least one of a title, a start time, a start date, an end time, an end date, a recording duration, a URL, a location in system memory, a recording quality identifier, recurring data, and connection settings.

19. The computer-implemented method as recited in claim 16, wherein enabling the user to schedule the recording includes enabling the user to create recurring recordings.

20. The computer-implemented method as recited in claim 16, wherein sending the scheduled recording task to the recording service includes interacting with the recording service through an application program interface.

21. The computer-implemented method as recited in claim 20, wherein the application program interface is a DCOM interface.

22. The computer-implemented method as recited in claim 16, wherein tracking the scheduled recording task includes obtaining a status of the scheduled recording task from the recording service.

23. The computer-implemented method as recited in claim 22, wherein tracking the scheduled recording task includes providing the status to the user.

24. The computer-implemented method as recited in claim 16, further comprising if the multimedia content stream is successfully recorded, enabling the user to access the recorded multimedia content stream.

25. One or more computer-readable memories containing a computer program that is executable by a processor to perform the computer-implemented method recited in claim 16.

26. An apparatus comprising:
means for receiving information about a multimedia content stream provided by a device coupled to a computer network;
means for scheduling a recording of the multimedia content stream at a specified time;
means for receiving the multimedia content stream from the location; and
means for saving the multimedia content stream in a storage device.

27. The apparatus as recited in claim 26, further comprising means for receiving the information from one or more application programs.

28. The apparatus as recited in claim 26, further comprising means for implementing a digital rights management (DRM) system.

29. An apparatus comprising:
means for enabling a user to schedule a recording of a multimedia content stream at a specified time;
means for creating a scheduled recording task that includes information about the recording;
means for sending the scheduled recording task to a recording service configured to perform the scheduled recording task; and
means for tracking the scheduled recording task.

30. The apparatus as recited in claim 29, further comprising means for providing a user interface to the user.

31. The apparatus as recited in claim 29, further comprising means for enabling the user to create recurring recordings.

32. One or more computer-readable media having stored thereon a computer program that, when executed by one or more processors, causes the one or more processors to:
determine information about a multimedia content stream provided at a device coupled to a computer network, wherein the determined information includes a specified time associated with the multimedia content stream;
schedule a recording of the multimedia content stream at the specified time; and
at the specified time,
receive the multimedia content stream from the device; and
save the multimedia content stream in a storage device.

33. One or more computer-readable media as recited in claim 32, wherein the computer program further causes the one or more processors to obtain the information from a user through a user interface.

34. One or more computer-readable media as recited in claim 32, wherein the computer program further causes the one or more processors to obtain the information from a content index.

35. A computer comprising:
a network interface configured to connect to a computer network; and
a memory that includes a scheduled recording service configured to receive a scheduled recording task that includes information about a multimedia content stream provided by a device in the computer network, schedule a recording of the multimedia content stream at a specified time, receiving the multimedia content stream from the device, and save the multimedia content stream in the memory.

36. The computer as recited in claim 35, wherein the scheduled recording service is further configured to provide an application program interface for interacting with application programs.

37. The computer as recited in claim 35, wherein the scheduled recording service is further configured to operate independent of a user account.

38. The computer as recited in claim 35, wherein the scheduled recording service is further configured to automatically establish a network connection with the device through the network interface for receiving the multimedia content stream.

39. The computer as recited in claim 38, wherein the scheduled recording service is further configured to specify a quality associated with the multimedia content stream.

40. The computer as recited in claim 35, wherein the scheduled recording service is further configured to maintain a configuration file that includes information about the scheduled recording task.

41. The computer as recited in claim 35, wherein the scheduled recording service is further configured to maintain a log file that includes a status associated with the scheduled recording task.

42. The computer as recited in claim 35, wherein the memory further includes a scheduling application configured to enable a user to schedule a recording of the multimedia content stream at the specified time, create the scheduled recording task that includes the information about the recording, send the scheduled recording task to the scheduled recording service; and track the scheduled recording task.

43. The computer as recited in claim 42, wherein the scheduling application is further configured to provide a user interface to the user for scheduling the recording.

44. The computer as recited in claim 42, wherein the scheduling application is further configured to provide a user interface to the user for tracking the recording.

45. The computer as recited in claim 42, wherein the scheduling application is further configured to enable the user to schedule recurring recordings.
